(19) United States
(12) Patent Application Publication
(10) Pub. No.: US 2022/0223038 A1
(43) Pub. Date: Jul. 14, 2022

(54) VEHICLE CONTROL SYSTEM AND SERVER DEVICE

(71) Applicant: HONDA MOTOR CO., LTD., Tokyo (JP)

(72) Inventors: Hidetoshi CHIKAMORI, Saitama (JP); Kazumasa NAKAMURA, Saitama (JP); Hitoshi KONISHI, Saitama (JP); Takuji HARAYAMA, Saitama (JP); Tomoaki MASAKAWA, Tokyo (JP); Naofumi ASO, Saitama (JP); Ryo MATSUZAWA, Tokyo (JP); Zhaoqi WANG, Tokyo (JP)

(21) Appl. No.: 17/573,121

(22) Filed: Jan. 11, 2022

(30) Foreign Application Priority Data
Jan. 12, 2021 (JP) 2021-002819

(51) Int. Cl. G08G 1/0967; G08G 1/01; G08G 1/0969; B60W 60/00

(52) U.S. Cl. CPC G08G 1/096725; G08G 1/0137; G08G 1/0969; B60W 2554/406; G08G 1/0108; G08G 1/0129; B60W 2556/45; B60W 60/001

(57) ABSTRACT

Provided is a system for properly avoiding a waiting-for-entrance congestion caused by vehicles that stop on a road to enter a facility along the road. A map server 3 is configured to: acquire probe information for identifying a traveling lane in which each vehicle is traveling; acquire, based on the probe information, a congestion occurrence condition when traffic congestion repeatedly occurs in a specific lane at a specific location with a predetermined regularity; and generate, based on the congestion occurrence condition, specific lane congestion information about a congestion status in the specific lane. A control device of a vehicle acquires the specific lane congestion information delivered from the map server, and controls, based on the specific lane congestion information, traveling of the vehicle so as to avoid traffic congestion that is predicted to occur in the specific lane.

### TECHNICAL FIELD

The present invention relates to a vehicle control system comprising a server device, and a control device for performing control for autonomous driving or driving assist using information delivered from the server device, as well as a server device used in such a system.

### BACKGROUND ART

When a user of a vehicle needs to use a facility such as a store along a road in order to park the vehicle at a parking lot or use a drive-through service, the user drives the vehicle to enter the facility from a lane along the edge of the road. When the vehicle cannot immediately enter the facility as it is full, the vehicle has to temporarily stop in the lane along the edge of the road. This can cause traffic congestion due to the vehicle that stops on the road, waiting to enter the facility. In this case, a vehicle that is not to enter the facility can also be involved in the traffic congestion. When such a vehicle cannot easily change lanes due to heavy traffic in the adjacent lanes, the vehicle has to stay involved in the traffic congestion, and be forced to waste time. Therefore, there is a need for technology to detect or predict such a waiting-for-entrance traffic congestion (i.e., a traffic congestion that occurs due to other vehicles waiting for entrance to a place along a road) occurring ahead of a vehicle, so that the vehicle can change lanes in advance in order to avoid the waiting-for-entrance traffic congestion.

Known such technologies related to waiting-for-entrance traffic congestions include a system for accurately detecting new installation and removal of traffic lights, which system can determine whether the reason why a vehicle stops on the road is related to traffic lights, or is not related to traffic lights such as when a vehicle waits to enter a store along the road (See Patent Document 1).

### PRIOR ART DOCUMENT (S)

### Patent Document(s)

Patent Document 1: JP2013-030006A

### SUMMARY OF THE INVENTION

### Task to be Accomplished by the Invention

In the above-described prior art, the system collects probe information from each vehicle and performs statistical processing operations on the probe information to thereby detect new installation and removal of traffic lights. However, the prior art document is silent as to detecting a waiting-for-entrance traffic congestion, and thus the system of the prior art cannot detect or predict a waiting-for-entrance traffic congestion occurring ahead of a vehicle so that the vehicle can properly avoid the waiting-for-entrance traffic congestion.

The present invention has been made in view of the problem of the prior art, and a primary object of the present invention is to provide a system for properly avoiding traffic congestion caused by a vehicle(s) waiting for entrance to a facility along a road.

### Means to Accomplish the Task

An aspect of the present invention provides a vehicle control system comprising: a server device; and a control device for performing control for autonomous driving or driving assist using information delivered from the server device, wherein the server device is configured to: acquire probe information that can be used to identify a traveling lane in which each vehicle is traveling; based on the probe information, acquire a condition for occurrence of traffic congestion when traffic congestion repeatedly occurs in a specific lane at a specific location with a predetermined regularity; and based on the condition for occurrence of traffic congestion, generate specific lane congestion information about a congestion status in the specific lane, and wherein the control device is configured to: acquire the specific lane congestion information delivered from the server device; and based on the specific lane congestion information, control traveling of a vehicle so as to avoid traffic congestion that is predicted to occur in the specific lane.

In this configuration, when congestion is predicted to occur in a specific lane of a road at a certain location because of other vehicles that stop on the road due to a condition specific to the location, a vehicle can be controlled to properly avoid the traffic congestion in the specific lane by changing lanes through autonomous driving or driving assist.

In the above configuration, the server device is preferably configured to generate, as the specific lane congestion information, information on traffic congestion caused by a vehicle(s) which stops in a lane along an edge of a road to enter a facility along the road from the lane.

In this configuration, when a waiting-for-entrance traffic congestion (i.e., a traffic congestion caused by other vehicles that stop on a lane along an edge of a road to enter a facility along the road from the lane) is predicted to occur, a vehicle can be controlled to properly avoid the traffic congestion in the specific lane by changing lanes.

Another aspect of the present invention provides a vehicle control system comprising: a server device; and a control device for controlling a vehicle, wherein the server device is configured to: acquire probe information that can be used to identify a traveling lane in which each vehicle is traveling; based on the probe information, acquire a condition for occurrence of congestion when traffic congestions repeatedly occur in a specific lane at a specific location with a predetermined regularity; and based on the condition for occurrence of traffic congestion, generate specific lane congestion information about a congestion status in the specific lane, and wherein the control device is configured to: acquire the specific lane congestion information delivered from the server device; and based on the specific lane congestion information, provide a driver of the vehicle with guidance for encouraging the driver to change lanes in order to avoid traffic congestion that is predicted to occur in the specific lane.

In this configuration, when congestion is predicted to occur in a specific lane of a road at a certain location because of other vehicles that stop on the road due to a condition specific to the location, a vehicle can be controlled to properly avoid the traffic congestion in the specific lane by encouraging a driver to change lanes through manual steering.

Yet another aspect of the present invention provides a server device for managing map information used in a control device of a vehicle for autonomous driving or driving assist, wherein the server device is configured to: acquire probe information that can be used to identify a traveling lane in which each vehicle is traveling; based on the probe information, acquire a condition for occurrence of traffic congestion when traffic congestion repeatedly occurs in a specific lane at a specific location with a predetermined regularity; based on the condition for occurrence of traffic congestion, generate specific lane congestion information about a congestion status in the specific lane; and deliver the map information and the specific lane congestion information to the control device.

In this configuration, when congestion is predicted to occur in a specific lane of a road at a certain location because of other vehicles that stop on the road due to a condition specific to the location, a vehicle can be controlled to properly avoid the traffic congestion in the specific lane by changing lanes through autonomous driving or driving assist.

### Effect of the Invention

According to the present invention, when congestion is predicted to occur in a specific lane of a road at a certain location because of other vehicles that stop on the road due to a condition specific to the location, a vehicle can be controlled to properly avoid the traffic congestion in the specific lane by changing lanes through autonomous driving or driving assist.

### BRIEF DESCRIPTION OF THE DRAWINGS

FIG. 1 is a block diagram showing a schematic configuration of a vehicle control system according to a first embodiment of the present invention;

FIG. 2 is a schematic diagram showing how a waiting-for-entrance traffic congestion occurs, and how a map server collects probe information;

FIG. 3 is a schematic diagram showing how specific lane congestion information is delivered to a vehicle and how the vehicle avoids the waiting-for-entrance traffic congestion; and

FIG. 4 is a schematic diagram showing how specific lane congestion information is delivered to a vehicle and how the vehicle avoids the waiting-for-entrance traffic congestion according to a second embodiment of the present invention.

### DESCRIPTION OF THE PREFERRED EMBODIMENT(S)

Embodiments of the present invention will be described in the following with reference to the appended drawings.

### First Embodiment

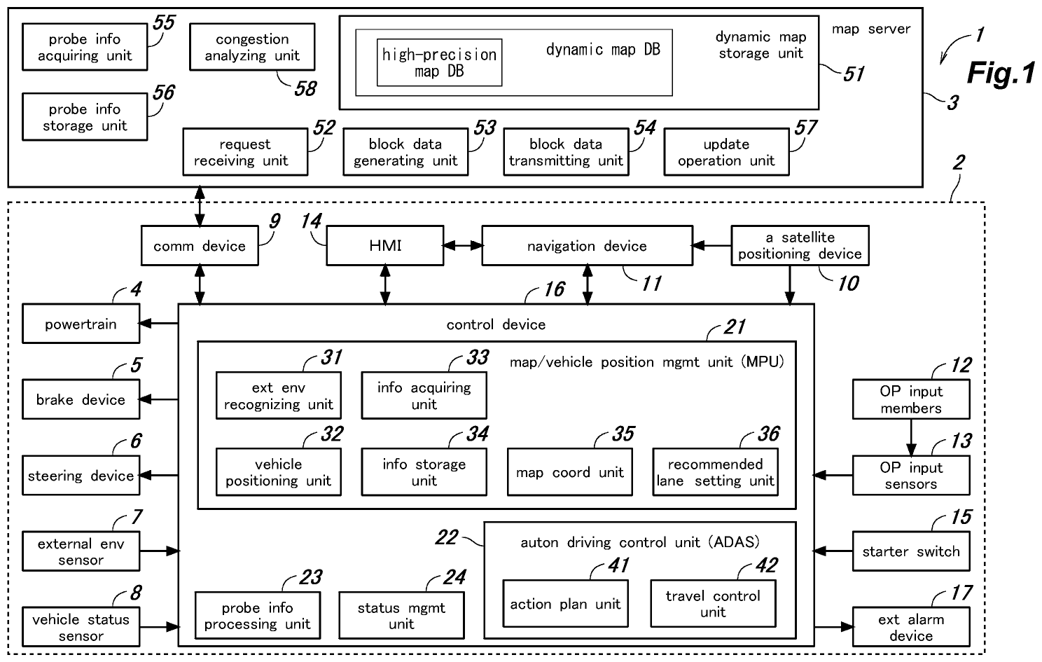

FIG. 1 is a block diagram showing a schematic configuration of a vehicle control system 1 according to a first embodiment of the present invention. The vehicle control system 1 includes a vehicle system 2 mounted in a vehicle and a map server 3 connected to the vehicle system 2 via a network.

The vehicle system 2 includes a powertrain 4, a brake device 5, a steering device 6, an external environment sensor 7, vehicle status sensors 8, a communication device 9, a satellite positioning device 10, a navigation device 11, operation input members 12, and operation input sensors 13, an HMI 14 (human-machine interface), a starter switch 15, a control device 16, and an external alarm device 17. These in-vehicle devices and elements, which constitute part of the vehicle system 2, are connected to each other through a communication network such as CAN (Control Area Network).

The powertrain 4, which provides a driving force to a vehicle, is a power source such that an electric motor or an internal combustion engine. The brake device 5 applies a braking force to a vehicle. The steering device 6 changes the steering angle of the wheels.

The external environment sensor 7 detects an object outside the vehicle by using electromagnetic waves, sound waves, or light reflected from an object located around the vehicle, and may include a radar, a laser radar (lidar), a sonar, and an external camera. The vehicle status sensor 8 detects the status of the vehicle, and may include a vehicle speed sensor and IMUs (Inertial Measurement Unit) for detecting a direction, a gyro, an acceleration, and an inclination state.

The communication device 9 is what is called a TSU (Telematics Service Unit). The communication device 9 communicates with other vehicles, roadside units, and the map server 3. Although communication methods usable by the communication device 9 are not limited to specific communication methods, the communication device 9 may perform communications through WiFi (Registered Trademark) networks, mobile communication networks (mobile phone networks), and/or V2X communications (vehicle-to-vehicle communications, roadside-device-to-vehicle communications).

The satellite positioning device 10 measures the position of the vehicle and outputs the position data (latitude/longitude) of the vehicle by using a satellite positioning system such as Global Navigation Satellite Systems (GNSS).

The navigation device 11 receives data of a destination which an occupant enters by operating the HMI 14, and sets a route (driving path) from the current location of the vehicle to the destination. The navigation device 11 displays the route from the current location of the vehicle to the destination in a screen displayed on the HMI 14, and provides a driver with guidance about the route by using a visual indication displayed on the HMI 14 or voice at an appropriate time.

The operation input members 12 are operated by a driver to drive the vehicle, and may include a steering wheel, an accelerator pedal, a brake pedal, a shift lever, a winker lever, and a power button. The operation input sensors 13 detect operations which a driver performs on the operation input members 12 and may include an accelerator sensor, a steering angle sensor, a brake sensor, and a grip sensor. The starter switch 15 is a switch for activating the vehicle system 2.

The HMI 14 (Human Machine Interface) 5 notifies an occupant(s) of various pieces of information, provides guidance to the occupant, and receives input operations performed by the occupant. The HMI 14 may include a display device (display) for indicating a navigation map on the screen, an input device such as a touch panel, a voice device (speaker) for outputting voice, and an autonomous driving selector switch for switching a driving mode between an autonomous driving mode and a manual operation mode.

The external alarm device 17 provides an alarm to a driver or a pedestrian outside the vehicle, and may include a winker (direction indicator).

The control device 16 includes a map/vehicle position management unit 21, an autonomous driving control unit 22, a probe information processing unit 23, and a status management unit 24. The control device 16 is an electronic control device (ECU) including a storage unit (such as ROM, RAM, HDD, or SSD) and a processor, and each functional unit of the control device 16 is implemented by the processor executing a program(s) stored in the storage unit. Each functional unit of the control device 16 may be composed of a single electronic control device or may be composed of a plurality of electronic control devices.

The map/vehicle position management unit 21 is what is called an MPU (Map Positioning Unit, high-precision vehicle positioning unit). The map/vehicle position management unit 21 includes an external environment recognizing unit 31, a vehicle positioning unit 32, an information acquiring unit 33, an information storage unit 34, a map coordination unit 35, and a recommended lane setting unit 36. The map/vehicle position management unit 21 includes a storage unit (such as ROM, RAM, HDD, or SSD) and a processor, and each functional unit of the map/vehicle position management unit 21 is implemented by the processor and programs stored in the storage unit.

The external environment recognizing unit 31 recognizes obstacles (such as guardrails, utility poles, vehicles, and pedestrians) located around the vehicle, lane markings on the road surface, road side ends based on detection results of the external environment sensor 7.

Based on the position data (latitude and longitude) of the vehicle acquired by the satellite positioning device 10, the vehicle positioning unit 32 identifies the current position of the vehicle in the high-precision map by combining the recognition result of the external environment recognizing unit 31 with the high-precision map in a coordinated fashion. The vehicle positioning unit 32 may identify the current position of the vehicle in the map by utilizing an autonomous navigation method based on a combination of the positioning result acquired by a satellite positioning system such as a GNSS system and the detection result of the IMU as the vehicle status sensor 8.

The information storage unit 34 holds various types of information required for autonomous driving of a vehicle. The information stored in the information storage unit 34 includes information constituting a dynamic map database (dynamic map DB).

Data of the dynamic map includes a combination of information classified into four layers; that is, static information, quasi-static information, quasi-dynamic information, and dynamic information. The static information is high-precision map data, which forms a high-precision map DB, including road surface information, lane information, and information on three-dimensional structures. Quasi-static information includes traffic regulation schedule information, road construction schedule information, wide area weather forecast information, and other related information. Semi-dynamic information includes accident information, road congestion information, traffic regulation information, road construction information, narrow area weather information, and other related information. Dynamic information includes real-time information such as information on vehicles and pedestrians on the road and information on signals.

The update frequencies of static information, quasi-static information, quasi-dynamic information, and dynamic information are different from each other. The dynamic information is updated, for example, once per second. The quasi-dynamic information is updated, for example, once a minute. The quasi-static information is updated, for example, once an hour. Static information is updated, for example, once a month.

The information acquiring unit 33 requests the latest data of a high-precision map to the map server 3 via the communication device 9 (TSU), to thereby acquire the high-precision map data transmitted from the map server 3 in response to the request. Specifically, the information acquiring unit 33 acquires the high-precision map data as a set of block data for predetermined block areas along the route of the vehicle based on the current position of the vehicle acquired by the vehicle positioning unit 32 and the route set by the navigation device 11.

The block data includes static information (high-precision map data) including information about lanes on each road along the route of the vehicle. When the high-precision map data stored in the information storage unit 34 is not the latest map data, the map server 3 delivers differential data between the stored map data and the latest high-precision map data to the control device, and the map/vehicle position management unit 21 performs a map updating operation to update the map data stored in the information storage unit 34 to the latest high-precision map data.

The block data includes quasi-static information such as traffic regulation information related to roads along the route and quasi-dynamic information such as road congestion information related to roads along the route.

In the present embodiment, the block data includes specific lane congestion information as quasi-dynamic information. The specific lane congestion information is congestion prediction information; that is, information about traffic congestion that is predicted to occur in the specific lane ahead of the vehicle.

The map coordination unit 35 performs a map coordination operation to replace a route in the navigation map (SD (Standard)-MAP) of the vehicle, the route being set by the navigation device 11, with a route in the high-precision map (HD (High Definition)-MAP).

The recommended lane setting unit 36 sets an optimum lane in each road section in the route along with the vehicle is to travel as a recommended lane, based on the route on the high-precision map acquired by the map coordination unit 35, and the quasi-dynamic information and the dynamic information included in the dynamic map data. For example, based on specific lane congestion information, the recommended lane setting unit 36 sets a recommended lane so as to avoid a section (congestion predicted section) in which a traffic congestion is predicted to occur due to a vehicle(s) that stops on a specific lane, waiting for entrance to a facility along the road.

The autonomous driving control unit 22 is a control unit used in ADAS (Advanced Driver-Assistance Systems). The autonomous driving control unit 22 includes an action plan unit 41 and a travel control unit 42.

The action plan unit 41 creates an action plan for driving the vehicle along the route for the vehicle set by the navigation device 11. Specifically, the action plan unit 41 determines a sequence of necessary events (i.e., events required to drive the vehicle along the recommended lane without contacting obstacles), and based on those events, generates a target track on which the vehicle is to travel. The target track is a sequence of points at which the vehicle should passes in time series.

The events set by the action plan unit 41 include: a constant speed traveling event which causes the vehicle to travel in the same lane at a constant speed; a lane change event which causes the vehicle to change lanes so that the vehicle travels on the recommended lane; a merging event which causes the vehicle to follow a road merging with another one; a branching event which causes the vehicle to travel towards a desired direction at a branching point on the road; and an intersection event which causes the vehicle to travel at an intersection.

The travel control unit 42 controls the vehicle according to the action plan generated by the action plan unit 41. Specifically, the travel control unit 42 controls the powertrain 4, the brake device 5, and the steering device 6 so that the vehicle follows the target track.

Autonomous driving generally has five levels, from mere driving assist (level 1) to fully autonomous driving (level 5). When the autonomous driving control unit 22 autonomously changes lanes to avoid a traffic congestion, the autonomous driving is at level 3 or level 4 or higher. The autonomous driving control unit 22 may assist the driver's steering operation so that the driver can smoothly change lanes to avoid traffic congestion.

The probe information processing unit 23 collects information on the driving condition of the vehicle at an appropriate time (for example, when a winker is operated or when a brake is operated) and stores the corrected information in a memory. The probe information processing unit 23 transmits information on the driving condition of the vehicle as probe information (travel history information) from the communication device 9 to the map server 3 at an appropriate time.

The probe information includes information records of the position and speed of the vehicle at each time. Moreover, the probe information includes information records identifying the traveling lane at each time. The probe information includes information records of the tilt of the roads acquired from the detection results of the vehicle status sensor 8 or other information. The probe information also includes congestion information acquired from the detection results of the vehicle status sensor 8 or other information. The probe information also includes road update information acquired from the detection results of the operation input sensor 13 and the external environment sensor 7.

The congestion information is information indicating that the vehicle is encountering a traffic congestion; that is, whether or not a traffic congestion is occurring in the traveling lane (i.e., the lane on which the vehicle is traveling). The congestion occurring in the traveling lane can be detected based on the vehicle speed detected by the vehicle status sensor 8. The probe information processing unit 23 can determine the traveling lane of the vehicle based on the high-precision map data stored in the map/vehicle position management unit 21, and thus determine in which lane the traffic congestion is occurring based on the information about the traveling lane and the congestion information.

The status management unit 24 switches a driving mode of the vehicle between a manual driving mode in which an occupant performs driving operations and an autonomous driving mode in which the vehicle autonomously travels. The driving mode can be switched between the manual driving mode and the autonomous driving mode in response to an occupant's operation. However, in an emergency, the control device switches the driving mode from the autonomous driving mode to the manual driving mode.

In the present embodiment, the control device 16 detects the traffic congestion in the traveling lane of the vehicle and reports the detection result of the traffic congestion to the map server 3 as probe information. However, in other embodiments, the map server 3 may detect the traffic congestion based on the vehicle speed included in the probe information. In some cases, the map server 3 may identify the traveling lane based on the position of the vehicle included in the probe information.

The map server 3 (server device) includes a dynamic map storage unit 51, a request receiving unit 52, a block data generating unit 53, a block data transmitting unit 54, and a probe information acquiring unit 55, a probe information storage unit 56, an update operation unit 57, and a congestion analyzing unit 58. The map server 3 is a computer provided with a storage unit (such as ROM, RAM, HDD, or SSD.) and a processor, and each functional unit of the map server 3 is implemented by the processor and programs in the storage unit. The map server 3 includes a communication unit for communicating with the control device 16 via a network (such as the Internet or mobile communication network). A data center and an edge server may cooperate to implement these functions of the map server 3.

The dynamic map storage unit 51 stores data constituting a dynamic map DB. The dynamic map includes static information (high-precision map information), quasi-static information, quasi-dynamic information, and dynamic information.

The request receiving unit 52 receives a dynamic map transmission request from each vehicle. When the request receiving unit 52 receives a dynamic map transmission request, based on the planned route and the current position of the vehicle, the block data generating unit 53 extracts data, the data corresponding to a predetermined area around the target vehicle and including the planned route of the target vehicle, from the dynamic map storage unit 51 to thereby generate block data. The block data transmitting unit 54 transmits the block data generated by the block data generating unit 53 to the vehicle.

The probe information acquiring unit 55 acquires probe information transmitted from each vehicle as appropriate. The probe information storage unit 56 stores probe information acquired by the probe information acquiring unit 55.

The update operation unit 57 performs statistical processing operations on the probe information stored in the probe information storage unit 56, and updates the dynamic map.

The congestion analyzing unit 58 analyzes probe information records of each vehicle stored in the probe information storage unit 56 to acquire (determine) a condition for occurrence of traffic congestion (a congestion occurring condition) when traffic congestions repeatedly occur in a specific lane at a specific location with a predetermined regularity, and based on the congestion occurring condition, generates specific lane congestion information regarding the occurrence of congestion in specific lanes (congestion prediction information for each lane).

The specific lane congestion information acquired by the congestion analyzing unit 58 is delivered to vehicles as quasi-dynamic information records of the dynamic map data along with other information such as the accident information and the narrow area weather information.

In the present embodiment, the map server 3 accumulates probe information collected from each vehicle, analyzes the probe information, and generates specific lane congestion information. However, in other embodiments, a dedicated server device, which is different from the map server 3, may be responsible for the accumulation of probe information and the analysis of the probe information.

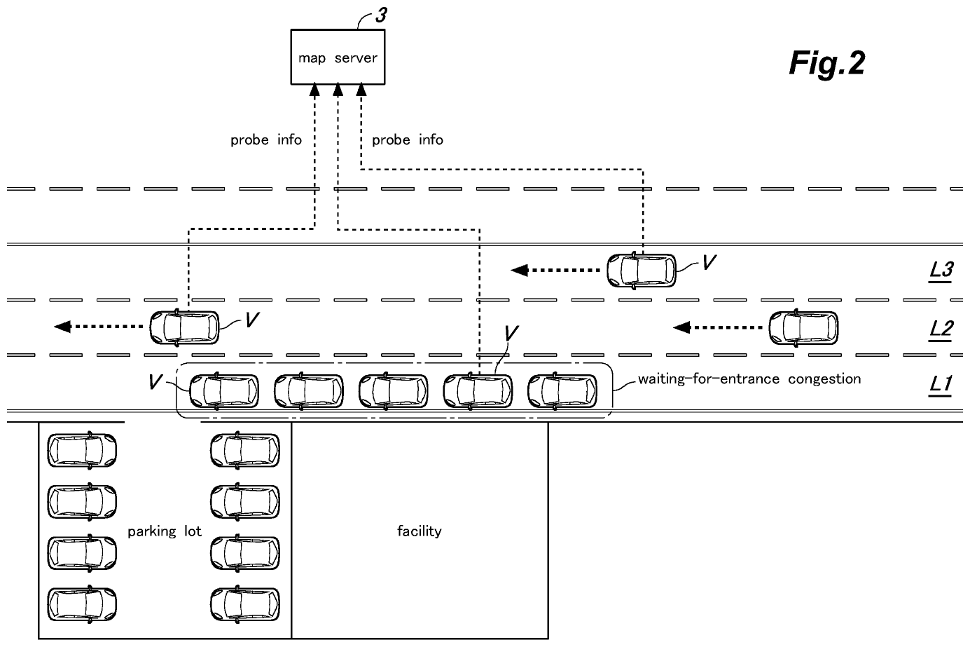

FIG. 2 is a schematic diagram showing how a waiting-for-entrance traffic congestion occurs, and how a map server collects probe information.

In the example shown in FIG. 2, a facility like a store with a parking lot is located along a road including a plurality of (three) lanes L1, L2, L3 on which vehicle are traveling in the same direction. In order to use the parking lot, a vehicle needs to enter the parking lot from lane L1 along the edge of the road (leftmost lane). However, when the parking lot is full and the vehicle V cannot enter the parking lot immediately, congestion can occur in the first lane L1 along the edge of the road. In the second lane L2 next to the first lane L1 and the third lane L3 next to the second lane L2, a vehicle V is traveling smoothly as there is no cause of traffic congestion.

The occurrence of such a waiting-for-entrance traffic congestion (i.e., a traffic congestion that occurs due to vehicles waiting for entrance to a place along a road) starts from a facility that causes the congestion (a specific location). A waiting-for-entrance traffic congestion occurs only in lane L1 (specific lane) along the edge of the road, and does not occur in the other lanes L2 and L3. A waiting-for-entrance traffic congestion occurs repeatedly with a predetermined regularity. A waiting-for-entrance traffic congestion substantially certainly occurs at the same time on the same day of the week, for example, when the store opens on a holiday. In this way, a waiting-for-entrance traffic congestion occurs repeatedly in a specific lane at a specific location with a predetermined regularity.

In the present embodiment, probe information (travel history information) representing the traveling status of a vehicle is uploaded from each vehicle to the map server 3. The probe information includes lane information on each lane on which the vehicle has traveled and congestion information indicating whether or not congestion has occurred in the lane, in addition to information records of the position and speed of the vehicle at each time.

In the example shown in FIG. 2, the probe information for the vehicle V traveling in the first lane L1 includes congestion information indicating the occurrence of traffic congestion in the first lane L1, while the probe information for the vehicles V traveling in the second and third lanes L2 and L3 does not include congestion information indicating occurrence of traffic congestion in the second and third lanes L2 and L3.

In the present embodiment, the control device 16 detects that the vehicle is encountering a traffic congestion; that is, that the traffic congestion is occurring in the traveling lane of the vehicle, based on information such as the speed of the vehicle, and then uploads the detection result, i.e.; the probe information including the congestion information to the map server 3. However, in other embodiments, the map server 3 may be configured to detect a traffic congestion.

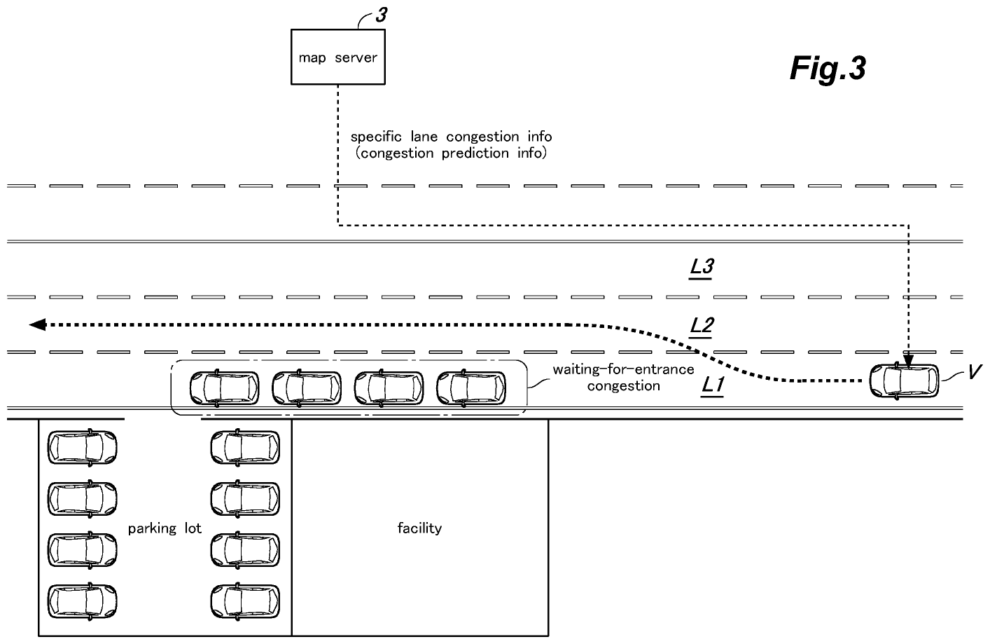

FIG. 3 is a schematic diagram showing how specific lane congestion information is delivered to a vehicle and how the vehicle avoids the waiting-for-entrance traffic congestion.

As shown in FIG. 2, the map server 3 collects probe information uploaded from each vehicle. This probe information includes lane information on the traveling lane of a vehicle and congestion information indicating whether or not there is congestion in the traveling lane, as well as the position data of the vehicle at each time. The position data, traveling lane information, and congestion information enables a driver of a vehicle to grasp how a congestion occurs in each lane.

The map server 3 analyzes probe information collected from each vehicle and detects a waiting-for-entrance congestion (congestion caused due to vehicles waiting for entrance); that is, a congestion caused due to vehicles that stop on a lane along the edge of a road to enter a facility along the road from that lane. Since a waiting-for-entrance congestion generally occurs repeatedly in a specific lane at a specific location with a predetermined regularity, the map server 3 specifies a condition (congestion occurrence condition) for the waiting-for-entrance congestion.

The congestion occurrence condition includes a position condition such as a congestion starting point, a lane, and a congestion section, and a time condition such as a day(s) of the week and a time (time zone) in which a congestion occurs. That is, the map server 3 identifies a position of a starting point of a waiting-for-entrance congestion that occurs periodically, a lane where the waiting-for-entrance congestion occurs, a congestion section (congestion length) of the waiting-for-entrance congestion, and a day of a week and a time (time zone) when the waiting-for-entrance congestion occurs. When acquiring a congestion occurrence condition, the map server 3 preferably identifies the facility that causes a waiting-for-entrance congestion. In this connection, an administrator of the map server 3 may designate in advance a facility that may cause a waiting-for-entrance congestion.

Next, the map server 3 predicts the occurrence of a waiting-for-entrance congestion in a specific lane at a specific location based on the congestion occurrence condition, and generates specific lane congestion information (congestion prediction information for each lane) regarding the occurrence of a waiting-for-entrance congestion. Specifically, when the present time meets the time condition of the congestion occurrence condition, the map server 3 generates specific lane congestion information indicating that a waiting-for-entrance congestion is predicted to occur in a lane as indicated in the position condition of the congestion occurrence condition.

Next, as shown in FIG. 3, the map server 3 delivers the specific lane congestion information to the vehicle's control device 16 as quasi-dynamic information in the dynamic map data. This specific lane congestion information includes information on a lane in which a congestion is predicted to occur and information on the location of a congestion predicted section (for example, information on the positions of the start point and end point of a congestion).

In the present embodiment, the map server 3 acquires a congestion occurrence condition based on probe information, generates specific lane congestion information based on the congestion occurrence condition, and delivers the specific lane congestion information to the control device 16. However, in other embodiments, the map server 3 may deliver information about a congestion occurrence condition to the control device 16, and the control device 16 may predict the occurrence of a congestion ahead of the vehicle based on the congestion occurrence condition.

The vehicle's control device 16 sets a recommended lane so as to avoid a section (congestion predicted section) in which congestion is predicted to occur due to a vehicle(s) that stops on a specific lane, waiting for entrance to a facility along the road, based on the specific lane congestion information acquired from the map server 3 by the map/vehicle position management unit 21 (MPU) and other information included in the dynamic map.

The vehicle's autonomous driving control unit 22 (ADAS) determines a sequence of events required for the vehicle to travel along the recommended lane, and based on the sequence of events, generates s a target track on which the vehicle is to travel. When the vehicle is traveling in a lane different from the recommended lane set to avoid congestion, that is, in a lane where congestion is predicted to occur, the vehicle's autonomous driving control unit 22 sets a lane change event which causes the vehicle to change lanes so that the vehicle travels on the recommended lane to thereby avoid congestion. The vehicle's autonomous driving control unit 22 sets a lane change event in consideration of a congestion length (the length of a train of vehicles in the congestion). Specifically, the vehicle's autonomous driving control unit 22 sets a lane change event that causes a vehicle to change lanes at a predetermined distance from a congestion prediction section, which distance is determined based on the vehicle's speed, so that the vehicle can change lanes well in advance of the time when the vehicle is expected to reach the congestion predicted section.

In the example shown in FIG. 3, the map/vehicle position management unit 21 sets the second lane L2, in which congestion is predicted to occur, as a recommended lane. Furthermore, when the vehicle V is traveling in the first lane L1 in which congestion is predicted to occur for some reason, the map/vehicle position management unit 21 is a lane change event that causes the vehicle to change lanes from the first lane L1 to the second lane L2. As a result, the vehicle V can change lanes from the first lane L1 to the second lane L2 before reaching a congestion predicted section of the first lane L1 where congestion is predicted to occur, to thereby avoid the waiting-for-entrance congestion in the first lane L1.

In the present embodiment, the vehicle control system is used to avoid a waiting-for-entrance congestion (i.e., a congestion caused due to a vehicle(s) that stops on a lane along the edge of a road to enter a facility along the road from that lane). However, a vehicle control system may be applied to avoid a congestion that is predicted to occur in a specific lane of a road at a certain location because of other vehicles that stop on the road due to a condition specific to the location (e.g., at a location where loading and unloading cargo occur regularly).

### Second Embodiment

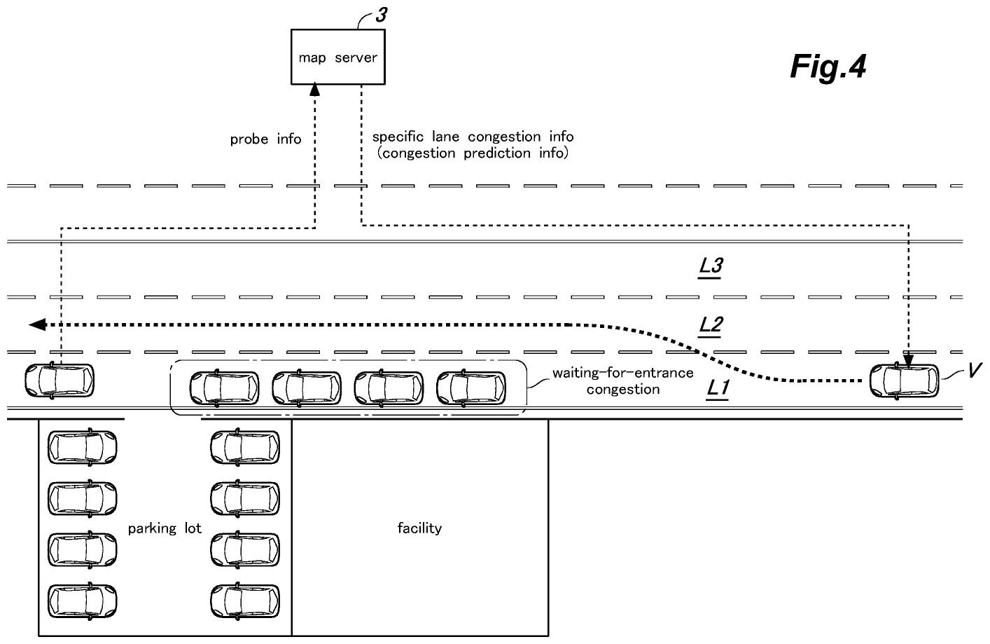

Next, a second embodiment of the present invention will be described. Except for what will be discussed here, this embodiment is the same as the above-described embodiment. FIG. 4 is a schematic diagram showing how specific lane congestion information is delivered to a vehicle and how the vehicle avoids the waiting-for-entrance traffic congestion according to the second embodiment.

In the first embodiment, the map server is configured to analyze probe information collected from each vehicle, determine a condition under which a waiting-for-entrance congestion can occur, and generate, based on the congestion occurrence condition, specific lane congestion information as prediction information, and deliver the specific lane congestion information as the prediction information to vehicles.

In the second embodiment, the map server generate, based on probe information collected from vehicles which are actually involved in congestion, specific lane congestion information as real-time actual information, and deliver the specific lane congestion information as real-time actual information to vehicles. The map server may be configured to deliver specific lane congestion information formed by integrating prediction information with real-time actual information, to vehicles.

In the case that the specific lane congestion information is real-time actual information, when probe information cannot be collected from any vehicle that is actually involved in congestion, the map server cannot deliver specific lane congestion information to vehicle. In the case that the specific lane congestion information is prediction information, even when probe information cannot be collected from any vehicle that is actually involved in congestion, the map server can deliver the specific lane congestion information to vehicles.

### Third Embodiment

Next, a third embodiment of the present invention will be described. Except for what will be discussed here, this embodiment is the same as the above-described embodiments.

In the above-described embodiments, when the control device 16 performs control for autonomous driving or driving assist and a waiting-for-entrance congestion is predicted to occur ahead of the traveling lane of the vehicle, the control device autonomously changes lanes to avoid the congestion.

In the present embodiment, when the vehicle is traveling in a manual operation mode, and a waiting-for-entrance congestion is predicted to occur ahead of the traveling lane of the vehicle, the control device notifies a driver that a waiting-for-entrance congestion is predicted to occur in the traveling lane ahead of the vehicle, and provides guidance for encouraging the driver to change lanes to the adjacent lane. The control device may provide such a notification and guidance to a driver through a visual screen using a display device (display) of the HMI 14 or through a voice output using a sound device (speaker9 of the HMI 14.

Such a notifications or guidance to a driver allows the driver to perform an operation to change lanes before being caught in a waiting-for-entrance congestion. Thus, even when the vehicle is traveling along a road a driver has not experienced and the driver does not know that a waiting-for-entrance congestion occurs regularly in the lane in which the vehicle is currently traveling, the control device can encourage the driver to properly avoid the waiting-for-entrance congestion.

### Glossary

1 vehicle control system
2 vehicle system
3 map server (server device)
16 control device
55 probe information acquiring unit
58 congestion analyzing unit

1. A vehicle control system comprising: a server device; and a control device for performing control for autonomous driving or driving assist using information delivered from the server device,
wherein the server device is configured to:
acquire probe information that can be used to identify a traveling lane in which each vehicle is traveling;
based on the probe information, acquire a condition for occurrence of traffic congestion when traffic congestion repeatedly occurs in a specific lane at a specific location with a predetermined regularity; and
based on the condition for occurrence of traffic congestion, generate specific lane congestion information about a congestion status in the specific lane, and
wherein the control device is configured to:
acquire the specific lane congestion information delivered from the server device; and
based on the specific lane congestion information, control traveling of a vehicle so as to avoid traffic congestion that is predicted to occur in the specific lane.

2. The vehicle control system according to claim 1, wherein the server device is configured to generate, as the specific lane congestion information, information on traffic congestion caused by a vehicle(s) which stops in a lane along an edge of a road to enter a facility along the road from the lane.

3. A vehicle control system comprising: a server device; and a control device for controlling a vehicle,
wherein the server device is configured to:
acquire probe information that can be used to identify a traveling lane in which each vehicle is traveling;
based on the probe information, acquire a condition for occurrence of congestion when traffic congestions repeatedly occur in a specific lane at a specific location with a predetermined regularity; and
based on the condition for occurrence of traffic congestion, generate specific lane congestion information about a congestion status in the specific lane, and
wherein the control device is configured to:
acquire the specific lane congestion information delivered from the server device; and
based on the specific lane congestion information, provide a driver of the vehicle with guidance for encouraging the driver to change lanes in order to avoid traffic congestion that is predicted to occur in the specific lane.

4. A server device for managing map information used in a control device of a vehicle for autonomous driving or driving assist,
wherein the server device is configured to:
acquire probe information that can be used to identify a traveling lane in which each vehicle is traveling;
based on the probe information, acquire a condition for occurrence of traffic congestion when traffic congestion repeatedly occurs in a specific lane at a specific location with a predetermined regularity;
based on the condition for occurrence of traffic congestion, generate specific lane congestion information about a congestion status in the specific lane; and
deliver the map information and the specific lane congestion information to the control device.
